(19) United States
(12) Patent Application Publication
(10) Pub. No.: US 2014/0050964 A1
(43) Pub. Date: Feb. 20, 2014

(54) ELECTRICAL ENERGY STORE

(71) Applicants: Michael Körösi, St. Ruprecht (AT); Harald Stuetz, Semriach (AT); Edward Yankoski, Graz (AT); Martin Michelitsch, Kumberg (AT); Mauro Aiolfi, Graz (AT)

(72) Inventors: Michael Körösi, St. Ruprecht (AT); Harald Stuetz, Semriach (AT); Edward Yankoski, Graz (AT); Martin Michelitsch, Kumberg (AT); Mauro Aiolfi, Graz (AT)

(73) Assignee: AVL LIST GMBH, Graz (AT)

(21) Appl. No.: 14/003,815

(22) PCT Filed: Mar. 8, 2012
(86) PCT No.: PCT/EP2012/054030

§ 371 Date: Oct. 29, 2013

(30) Foreign Application Priority Data
Mar. 9, 2011 (AT) A 320/2011

(51) Int. Cl. H01M 10/50

(52) U.S. Cl. CPC H01M 10/5044
USPC 429/120

(57) ABSTRACT

An electrical energy storage device for motor vehicles. The electrical energy storage device includes at least one battery module with a plurality of individual cells which are arranged in a stack between two outer end plates. At least one individual cell is arranged in an individual module.

### CROSS-REFERENCE TO RELATED APPLICATIONS

The present application is a National Stage Application of PCT International Application No. PCT/EP2012/054030 (filed on Mar. 8, 2012), under 35 U.S.C. §371, which claims priority to Austrian Patent Application No. A 320/2011 (filed on Mar. 9, 2011), which are each hereby incorporated by reference in their respective entireties.

### TECHNICAL FIELD

The invention relates to an electrical energy storage device, especially for motor vehicles, comprising at least one battery module with a plurality of individual cells which are arranged in a stack between two outer end plates, wherein preferably at least one individual cell is arranged in an individual module.

### BACKGROUND

It is known to carry out the cooling and/or heating of a battery module with a cooling medium. It is disadvantageous that cooling medium connections are required for this purpose and that the cooling ducts in the battery module need a relatively large amount of space. The relatively large number of components also has a negative effect on the production costs.

### SUMMARY

It is the object of the invention to avoid these disadvantages and to provide optimal conditioning of the battery modules with little effort.

This is achieved in accordance with the invention in such a way that a preferably flexible electrical heating element is arranged between at least two individual cells, preferably between two individual modules, wherein preferably the heating element is formed by a preferably flexible heating foil. The flexible configuration allows an adjustment to the contour.

The heating element can be a resistance heating element with heating wires.

It is especially advantageous that the heating element is surrounded at least partially by a cooling element, and is welded by laser. The cooling element may be formed by a cooling plate, preferably made of sheet metal. It is also possible that the cooling plate consists of plastic.

A particularly good cooling effect can be achieved when the cooling element is extensively folded around the heating element and thus covers both sides of the heating element. Likewise, one-sided contacting of the cooling element with the heating element is also possible.

The cooling element may be glued to the heating element. Alternatively or additionally, the connection between the heating element and cooling element can be provided by an interlocking connection.

### DRAWINGS

The invention will be explained below in closer detail by reference to the drawings, wherein:

FIG. 1 illustrates an energy storage device in accordance with the invention in a perspective view.

FIG. 2 illustrates a stack of individual cells of this energy storage device in a perspective view.

FIG. 3 illustrates the stack in a side view.

FIG. 4 illustrates a heating and cooling element in a perspective view.

FIG. 5 illustrates the heating and cooling element in a partly sectional perspective view.

FIG. 6 illustrates the heating and cooling element in a perspective view.

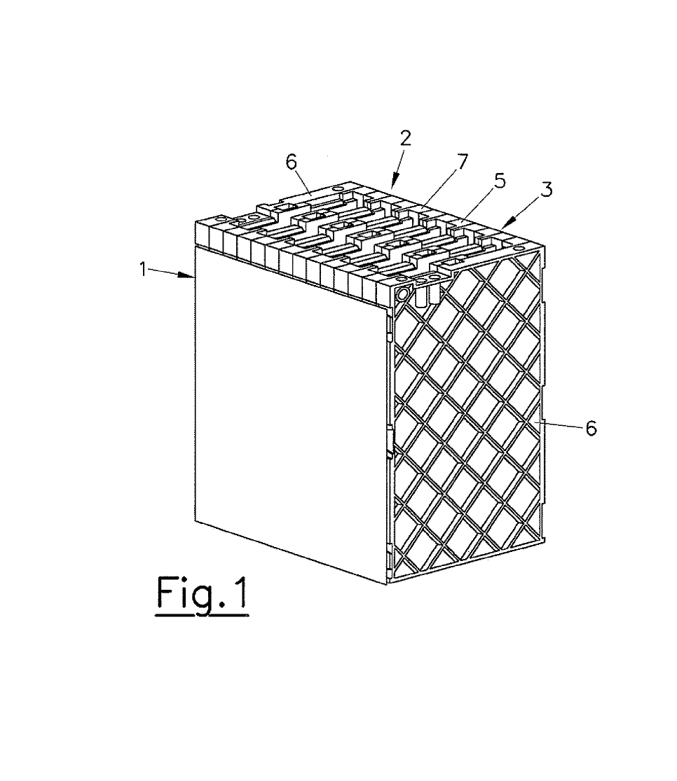

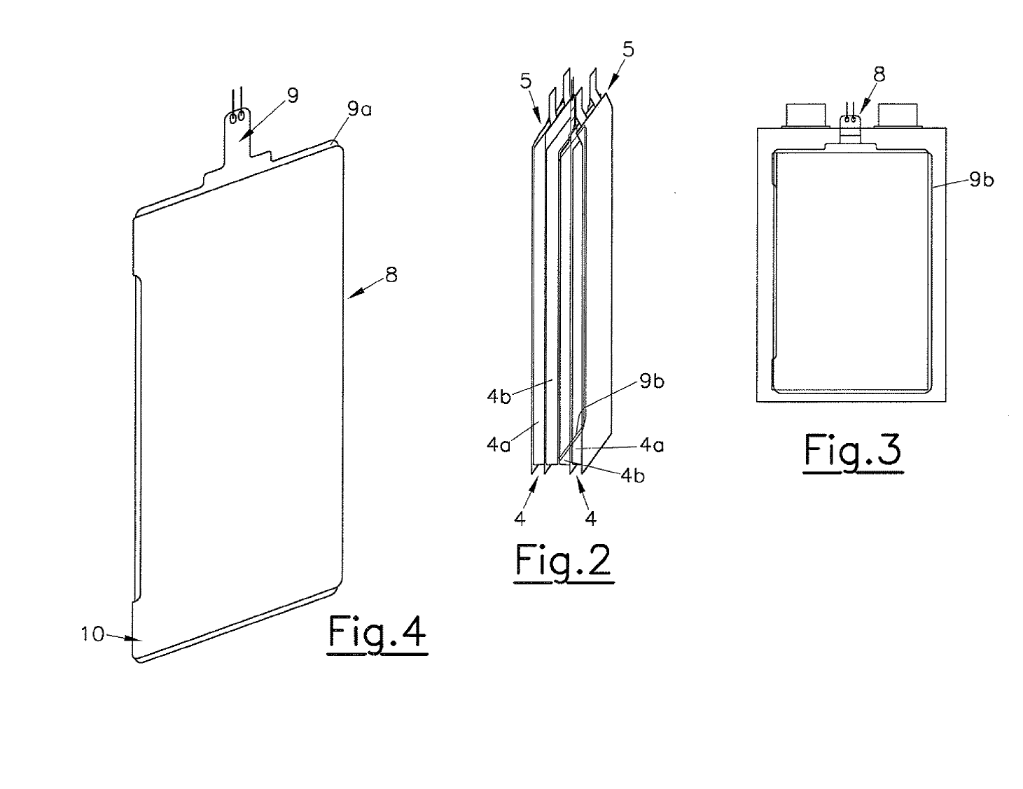

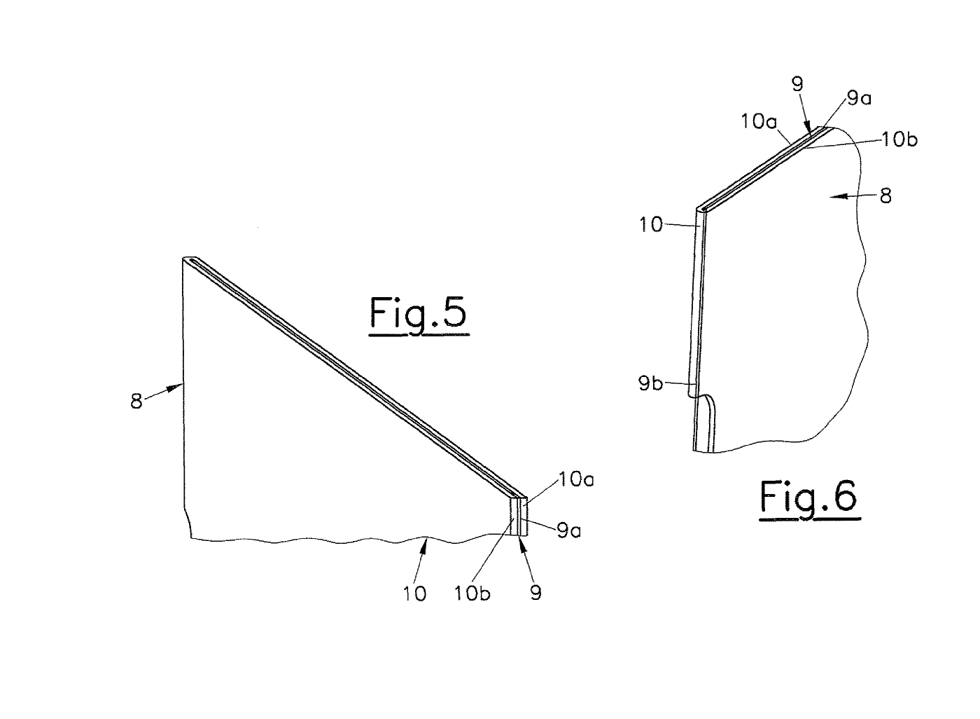

### DESCRIPTION

The electrical energy storage device 1 contains at least one battery module 2 with a stack 3 of individual modules 5 comprising individual cells 4a, 4b, wherein one respective end plate 6 is arranged at each end of the stack. Each individual module 5 has an individual cell frame 7, wherein each individual cell frame accommodates a pair of cells 4 with a first and a second individual cell 4a, 4b in the embodiment.

A combined heating and cooling unit 8 with a heating element 9 and a cooling element 10 is arranged between two adjacent cells 4b and/or between two adjacent individual modules 5.

The heating element is formed by a thin flexible heating foil 9a, which may comprise resistance wires 9b. The flexible form allows an adaptation to different surfaces. The heating element 9a is surrounded by a cooling element 10 made of folded sheet for example and is welded by laser. As a result, the cooling element forms a cooling plate 10a, 10b at both sides of the heating element, which cooling plate lies flat on the individual cells of the battery module 2. The heating and cooling unit 8 may be clamped between two individual cells 7, and thus provide maximum possible surface contact to the adjacent individual cells 4b. The heat removal by the cooling plates 10a, 10b can be made by air or liquid cooling. Optionally, Peltier elements can also be used for cooling.

The connection between the cooling element 10 and the heating element 9 can occur by gluing or by an interlocking connection.

As a result of the extremely thin and flat configuration, the heating and cooling unit 8 only needs a low amount of space. The flat contact ensures especially good heat transmission.

1-9. (canceled)

10. An electrical energy storage device, comprising:
at least one battery module with a plurality of individual cells which are arranged in a stack between two outer end plates, wherein at least one of the individual cells is arranged in an individual module; and
a flexible electrical heating element arranged between at least two individual cells.

11. The electrical energy storage device of claim 10, wherein the heating element comprises a flexible heating foil.

12. The electrical energy storage device of claim 10, further comprising a cooling element which at least partially surrounds the heating element.

13. The electrical energy storage device of claim 12, wherein the cooling element comprises a cooling plate.

14. The electrical energy storage device of claim 12, wherein the cooling plate is composed of sheet metal.

15. The electrical energy storage device of claim 14, wherein the cooling element is folded around the heating element.

16. The electrical energy storage device of claim 15, wherein the heating element and/or cooling element is clamped between the individual cell frames of adjacent individual modules and rests on the individual cells.

17. The electrical energy storage device of claim 15, wherein the cooling element and the heating element are connected to each other.

18. The electrical energy storage device of claim 15, wherein the cooling element and the heating element are connected to each other by an adhesive.

19. The electrical energy storage device of claim 15, wherein the cooling element and the heating element are connected to each other by interlocking connection.

20. The electrical energy storage device of claim 15, wherein the heating element and the cooling element form a combined heating and cooling unit.

21. The electrical energy storage device of claim 10, wherein each individual module comprises an individual cell frame.

22. An electrical energy storage device for a motor vehicle, the electrical energy storage device comprising:
a battery module with a an individual module having a plurality of individual cells arranged between outer end plates;
a heating element arranged between the individual cells; and
a cooling element which at least partially surrounds the heating element.

23. The electrical energy storage device of claim 22, wherein the heating element comprises a flexible heating foil.

24. The electrical energy storage device of claim 22, wherein the cooling element comprises a cooling plate.

25. The electrical energy storage device of claim 22, wherein the cooling element is folded around the heating element.

26. The electrical energy storage device of claim 22, wherein the heating element and/or cooling element is clamped between the individual cells.

27. The electrical energy storage device of claim 22, wherein the cooling element and heating element are connected to each other.

28. The electrical energy storage device of claim 22, wherein the cooling element and the heating element are connected to each other.

29. The electrical energy storage device of claim 22, wherein the heating element and the cooling element form a combined heating and cooling unit.
